(19) United States
(12) Patent Application Publication
(10) Pub. No.: US 2025/0116396 A1
(43) Pub. Date: Apr. 10, 2025

(54) PLANT GROWING LAMP

(71) Applicant: Liang LIU, Shenzhen City (CN)

(72) Inventor: Liang LIU, Shenzhen City (CN)

(73) Assignee: Guangdong Hengtai Lighting Technology Co., Ltd., Zhongshan City (CN)

(21) Appl. No.: 18/983,325

(22) Filed: Dec. 16, 2024

(51) Int. Cl. F21V 21/088; F21V 17/12; F21V 17/16; F21V 21/108; F21V 21/32; F21W 131/30; F21Y 115/10

(52) U.S. Cl. CPC F21V 21/088; F21V 17/12; F21V 17/16; F21V 21/108; F21V 21/32; F21W 2131/30; F21Y 2115/10

(57) ABSTRACT

A plant growing lamp includes a lamp body, a power supply, and a fixing device, the fixing device includes an upper clip body and a lower clip body; the upper clip body is hollow; one end of the lamp body is inserted from the upper clip body and is fixed; and the power supply is electrically connected to the lamp body. By the arrangement of the above structure, the lamp body, the upper clip body, and the lower clip body can be produced separately during use, which is convenient for standardized production and assembling. The lamp body is stably mounted at a suitable position through the fixing device, and the power supply is electrically connected to the lamp body, so that the entire lamp can provide a stable and continuous lighting service for a specific environment to meet lighting needs of different plants.

### TECHNICAL FIELD

The present disclosure relates to the technical field of lamps, and in particular, to a plant growing lamp.

### BACKGROUND OF THE INVENTION

With the development of the economy, the living standard is increasingly high. In daily life, most people choose to keep indoor potted plants. During growth of plants, the illumination intensity and the illumination time are main factors affecting the growth of the plants. When the natural sunlight cannot meet growth needs of the plants, a lamp needs to be used to enhance the illumination intensity and prolong the illumination time. Using a plant growing lamp can meet a lighting requirement through artificial light, instead of natural light, so that plants can be planted indoors throughout the year.

On the market, most plant growing lamps are hung on frames at fixed positions or on ceilings. There are also clip-on plant growing lamps which can be fixed at desired positions using clips. However, for the current clip-on plant growing lamp, due to the inherent nature of the clip, the clip is then assembled only after a lamp body is assembled to an upper clip body. A processing method for this clip structure is cumbersome, inefficient, and not convenient for standardized production. Moreover, due to the inherent nature of the clip structure, it is not possible to provide a receiving space to receive and organize a wire electrically connected to the lamp body. At the clip, the wire easily has natural loss due to direct exposure to a natural environment. Especially when one clip is connected to a plurality of lamp bodies, a plurality of strands of wires are also prone to entanglement, which further increases the natural loss.

Therefore, the present disclosure provides a plant growing lamp with a simple structure, which can effectively solve the above-mentioned problems.

### SUMMARY OF THE INVENTION

To overcome the shortcomings in the prior art, the present disclosure provides a plant growing lamp with a simple structure. A clip can be first assembled, and a lamp body is then mounted. Furthermore, it is convenient for standardized production. Meanwhile, a plurality of strands of wires are also prone to entanglement, so that a receiving space attached to the clip is provided to prevent the entanglement of the plurality of strands of wires and protect the wires, thereby reducing the speed of natural loss and prolonging the service life of the product.

The technical solution adopted by the present invention to solve the technical problem is as follows.

A plant growing lamp includes a lamp body, a power supply, and a fixing device, the fixing device includes an upper clip body and a lower clip body; the upper clip body is hollow; one end of the lamp body is inserted from the upper clip body and is fixed; and the power supply is electrically connected to the lamp body.

As an improvement of the present invention, the upper clip body includes an accommodating housing and a mounting sheet; the lamp body is fixed to the accommodating housing; and the accommodating housing is detachably connected to the mounting sheet.

As an improvement of the present invention, the mounting sheet is provided with an upper hinge part; the lower clip body is provided with a lower hinge part; and the upper hinge part is hinged to the lower hinge part, so that the mounting sheet is rotatably connected to the lower clip body.

As an improvement of the present invention, the accommodating housing is provided with an upper hinge part; the lower clip body is provided with a lower hinge part; and the upper hinge part is hinged to the lower hinge part, so that the mounting sheet is rotatably connected to the lower clip body.

As an improvement of the present invention, the mounting sheet is provided with a mounting clamping part; the accommodating housing is provided with a housing clamping part; and the mounting clamping part is in snap-in connection with the housing clamping part, so that the accommodating housing is connected to the mounting sheet.

As an improvement of the present invention, the mounting clamping part includes a plurality of clamping slots; the housing clamping part includes a plurality of clamping plates; the clamping plates are in snap-in connection with the clamping slots; and the mounting clamping part is connected to the housing clamping part.

As an improvement of the present invention, the mounting sheet is provided with a mounting clamping part; the accommodating housing is provided with a housing clamping part; and the mounting clamping part is in snap-in connection with the housing clamping part, so that the accommodating housing is connected to the mounting sheet.

As an improvement of the present invention, the mounting clamping part includes a plurality of clamping slots; the housing clamping part includes a plurality of clamping plates; the clamping plates are in snap-in connection with the clamping slots; and the mounting clamping part is connected to the housing clamping part.

As an improvement of the present invention, the accommodating housing is provided with a clamping sliding chute; and a contour of the clamping sliding chute is matched with an edge contour of the mounting sheet, so that the mounting sheet is slidably connected to the accommodating housing.

As an improvement of the present invention, the accommodating housing is provided with a housing threaded part; the mounting sheet is provided with a mounting threaded part; and the housing threaded part is in threaded connection to the mounting threaded part, so that the accommodating housing is detachably connected to the mounting sheet.

As an improvement of the present invention, the accommodating housing is further provided with a pre-mounting slot.

As an improvement of the present invention, the pre-mounting slot is formed by outward sinking of an inner wall of the accommodating housing, and the pre-mounting slot does not penetrate through the accommodating housing.

As an improvement of the present invention, at least one pre-mounting slot is provided.

As an improvement of the present invention, the lamp body includes a light-emitting main body, a connecting wire, and a flexible coil; the connecting wire includes a current output end and a current input end; the current output end of the connecting wire is electrically connected to the light-emitting main body; the current input end of the connecting wire is electrically connected to the power supply; the flexible coil includes a first end and a second end; the light-emitting main body is attached to the first end of the flexible coil; the connecting wire is arranged in the flexible coil; and the upper clip body is attached to the second end of the flexible coil.

As an improvement of the present invention, an accommodating space and a power connection wire are arranged in the accommodating housing; the accommodating housing is provided with a wire hole; the accommodating housing defines the accommodating space; the wire hole is provided in the accommodating housing; the wire hole is communicated to the accommodating space; the accommodating space is configured to accommodate the power connection wire; and the power connection wire is configured to integrate the current input end of the connecting wire.

As an improvement of the present invention, the wire hole is provided in a side wall of the accommodating housing.

As an improvement of the present invention, a circuit board is further arranged in the accommodating housing; and the power connection wire integrates the current input end of the connecting wire through the circuit board.

As an improvement of the present invention, the light-emitting main body includes at least one light-emitting diode (LED) lamp module.

As an improvement of the present invention, the accommodating housing is provided with a mounting hole; a mounting part is arranged at the second end of the flexible coil; and the mounting hole is fixedly connected to the mounting part, so that the flexible coil is connected to the accommodating housing.

As an improvement of the present invention, the mounting part includes a nut and a threaded pipe; the threaded pipe is in threaded connection to the nut after passing through the mounting hole, so that the flexible coil is connected to the accommodating housing.

Beneficial effects: By the arrangement of the above structure, the lamp body, the upper clip body, and the lower clip body can be produced separately during use, which is convenient for standardized production and assembling. The lamp body is stably mounted at a suitable position through the fixing device, and the power supply is electrically connected to the lamp body, so that the entire lamp can provide a stable and continuous lighting service for a specific environment to meet lighting needs of different plants, ensure that a function of prompting growth of plants by artificial lighting can be reliably achieved, prolong the service lives of the components of the lamp, and reduce the probability of failure caused by shaking, poor connection, and other problems.

### BRIEF DESCRIPTION OF DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work. In addition, the accompanying drawings are not drawn to a scale of 1:1, and the relative dimensions of the various elements are only shown as examples in the diagrams, not necessarily drawn to a true scale.

The present disclosure is further described below in detail in combination with the accompanying drawings and embodiments.

FIG. 1 is a schematic diagram of a first entire structure according to Embodiment 1 of the present disclosure;

FIG. 2 is a schematic diagram of a first exploded structure according to Embodiment 1 of the present disclosure;

FIG. 3 is a schematic diagram of a second exploded structure according to Embodiment 1 of the present disclosure;

FIG. 4 is a schematic diagram of a second entire structure according to Embodiment 1 of the present disclosure;

FIG. 5 is a schematic diagram of an entire structure according to Embodiment 2 of the present disclosure;

FIG. 6 is a schematic diagram of an exploded structure of a fixing device 300 according to Embodiment 2 of the present disclosure;

FIG. 7 is a schematic diagram of an entire structure according to Embodiment 3 of the present disclosure;

FIG. 8 is a schematic diagram of an exploded structure of a fixing device 300 according to Embodiment 3 of the present disclosure;

FIG. 9 is a schematic diagram of an entire structure according to Embodiment 4 of the present disclosure; and

FIG. 10 is a schematic diagram of an exploded structure of a fixing device 300 according to Embodiment 4 of the present disclosure.

### DETAILED DESCRIPTION OF THE INVENTION

To make the aforementioned objectives, features, and advantages of the present disclosure more comprehensible, specific implementations of the present disclosure are described in detail below in conjunction with the accompanying drawings. In the following description, numerous specific details are set forth to provide a thorough understanding of the present disclosure. The present disclosure may, however, be embodied in many forms different from that described here. A person skilled in the art can make similar improvements without departing from the connotation of the present disclosure. Therefore, the present disclosure is not limited by the specific embodiments disclosed below.

In the description of the present disclosure, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present disclosure and simplifying the description, Rather than indicating or implying that the indicated device or element must have a particular orientation, be constructed and operated in a particular orientation, therefore, not to be construed as limiting the present disclosure.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present disclosure, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present disclosure can be understood based on specific circumstances.

In the present disclosure, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

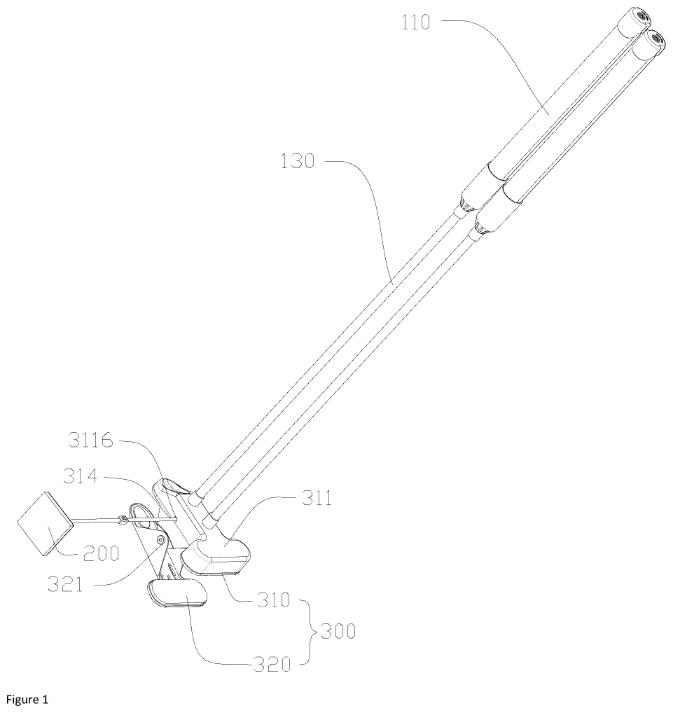

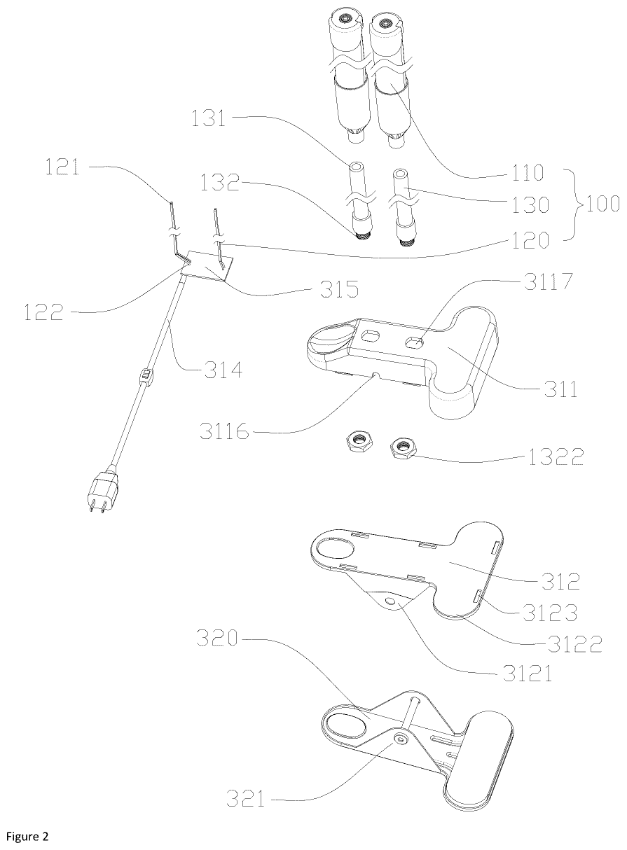

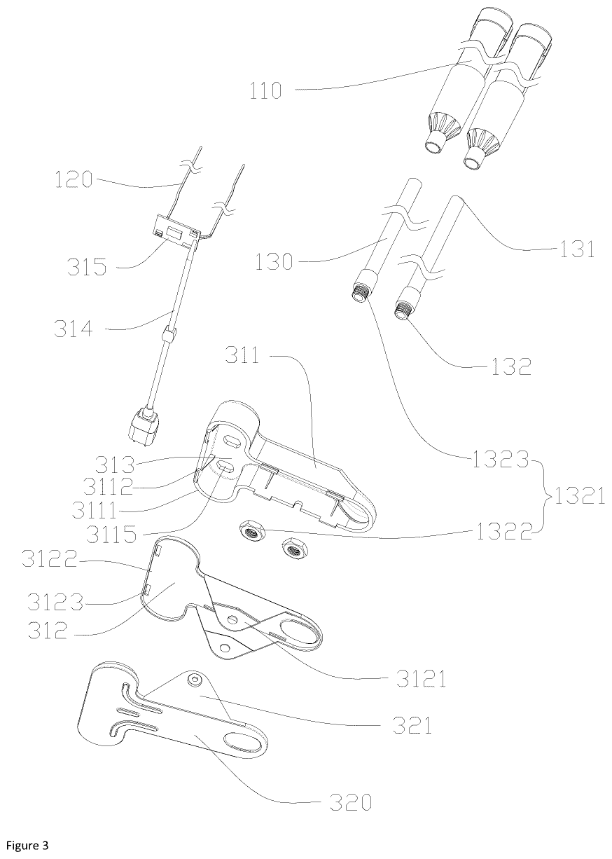

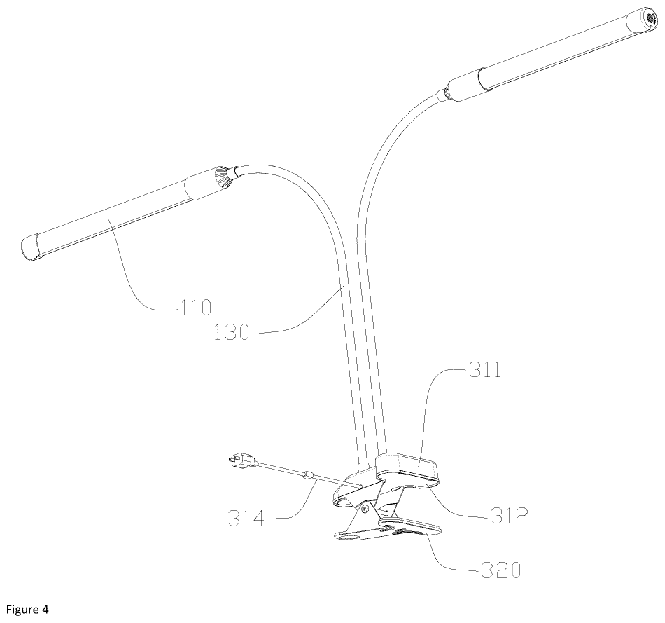

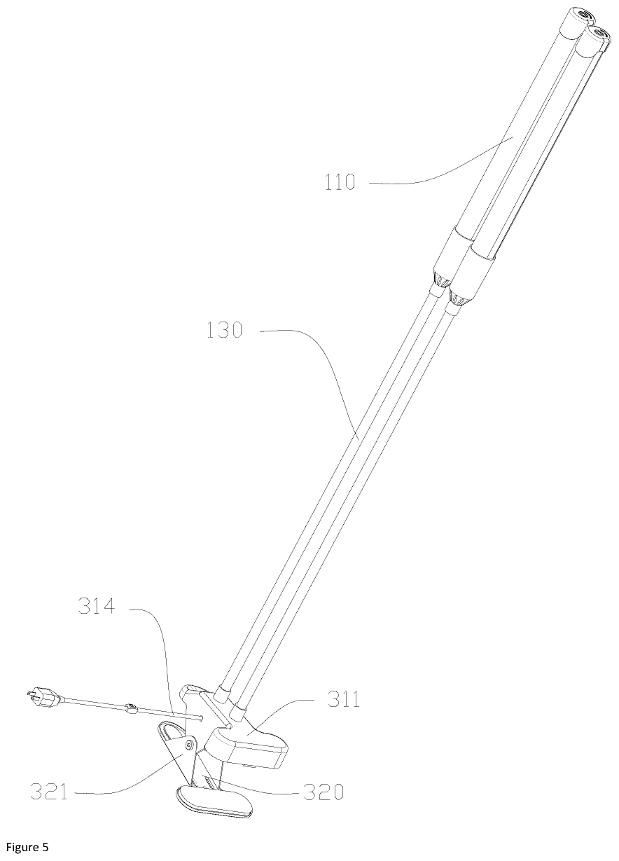

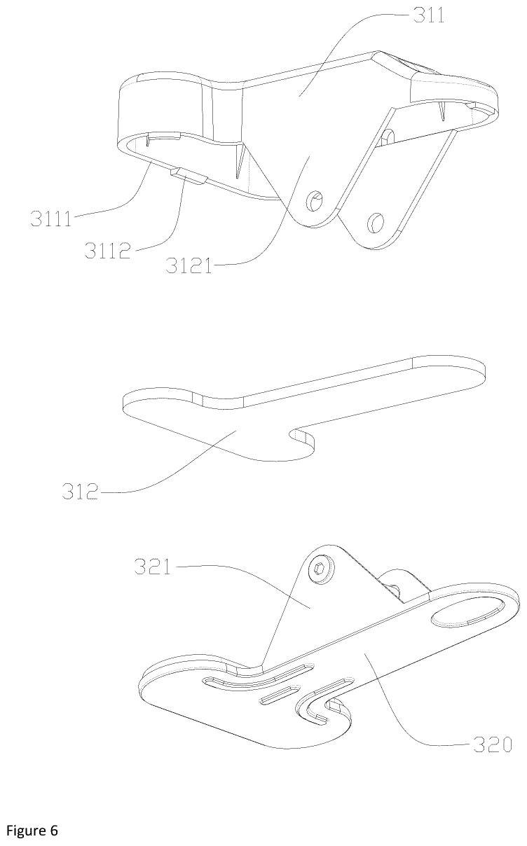

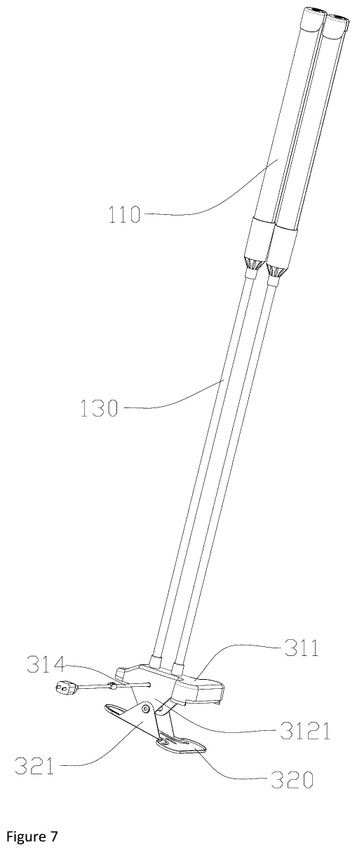

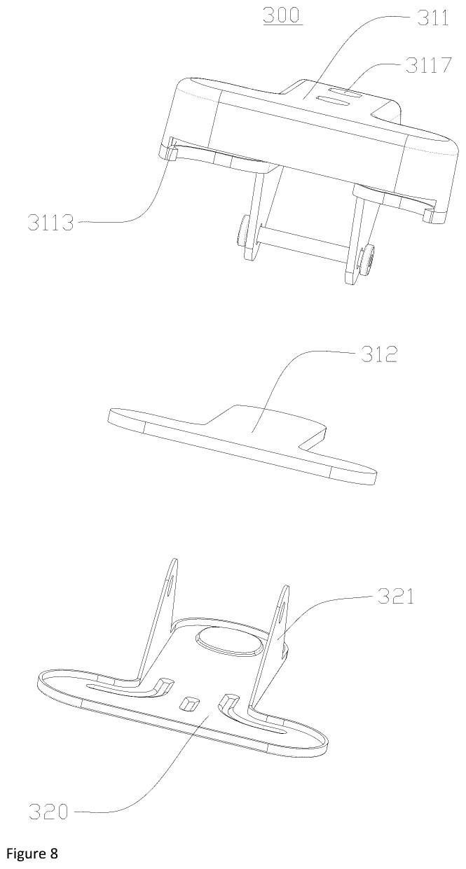

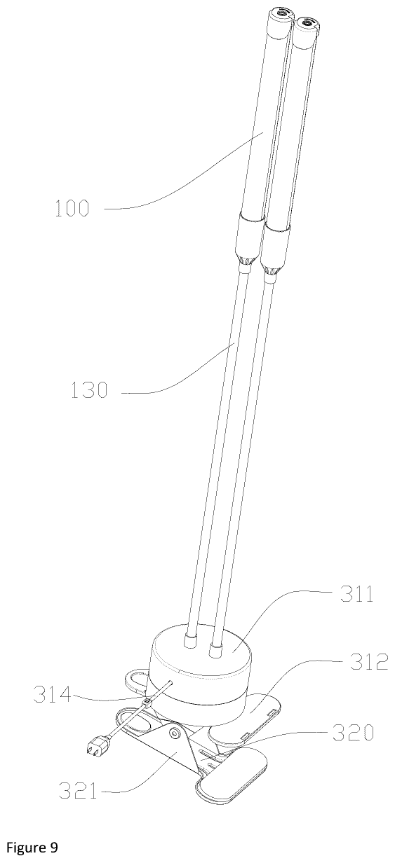

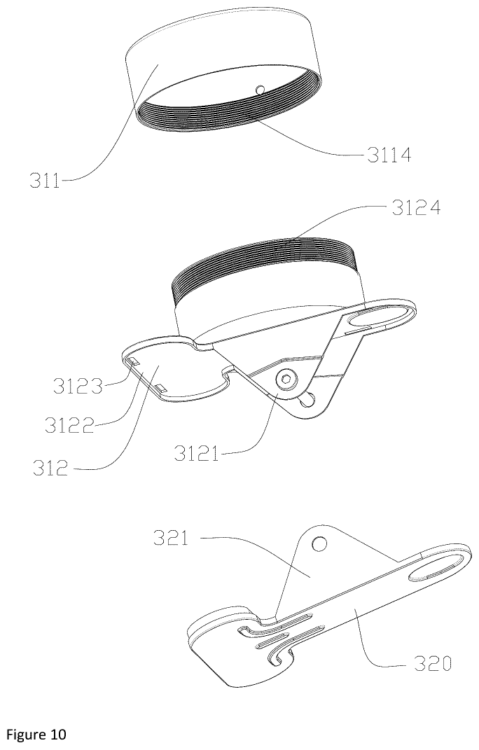

The present disclosure will be further described in detail below in conjunction with FIG. 1 to FIG. 10.

### Embodiment 1

This embodiment of the present disclosure discloses a plant growing lamp, including:
a lamp body 100, a power supply 200, and a fixing device 300. The fixing device 300 includes an upper clip body 310 and a lower clip body 320. The upper clip body 310 is hollow. One end of the lamp body 100 is inserted from the upper clip body 310 and fixed. The power supply 200 is electrically connected to the lamp body 100.

By the arrangement of the above structure, the lamp body 100, the upper clip body 310, and the lower clip body 320 can be produced separately during use, which is convenient for standardized production and assembling. The lamp body 100 is stably mounted at a suitable position through the fixing device 300, and the power supply 200 is electrically connected to the lamp body 100, so that the entire lamp can provide a stable and continuous lighting service for a specific environment to meet lighting needs of different plants, ensure that a function of prompting growth of plants by artificial lighting can be reliably achieved, prolong the service lives of the components of the lamp, and reduce the probability of failure caused by shaking, poor connection, and other problems.

In this embodiment, the upper clip body 310 includes an accommodating housing 311 and a mounting sheet 312; the lamp body 100 is fixed to the accommodating housing 311; and the accommodating housing 311 is detachably connected to the mounting sheet 312. By the arrangement of the above structure, the design of detachable connection makes the entire lamp system more convenient for maintenance and component replacement during use. If the lamp body 100 fails or is damaged, the detachable structures allow a user to quickly separate the accommodating housing 311 from the mounting sheet 312, and then remove the lamp body 100 for maintenance or replacement. Similarly, if the accommodating housing 311 is damaged or aged itself, the accommodating housing 311 can also be replaced separately, thereby reducing the maintenance costs and lowering the maintenance difficulty. Meanwhile, in production and assembling processes of the lamp, this detachable connection mode is beneficial for separate production and transportation of the components. The accommodating housing 311 and the mounting sheet 312 can be produced on different production lines or in different factories, and then are combined at a final assembling site, thereby improving the production efficiency. During transportation, the components are transported after being disassembled, which can reduce the overall volume of the lamp and reduce the transportation costs.

In this embodiment, the mounting sheet 312 is provided with an upper hinge part 3121; the lower clip body 320 is provided with a lower hinge part 321; and the upper hinge part 3121 is hinged to the lower hinge part 321, so that the mounting sheet 312 is rotatably connected to the lower clip body 320. By the arrangement of the above structure, during use, the mounting sheet 312 and the lower clip body 320 are movably connected to form a clamping part of the fixing device 300. This structure enables the clamping part to adapt to supporting objects with different shapes and sizes.

In this embodiment, the mounting sheet 312 is provided with a mounting clamping part 3122; the accommodating housing 311 is provided with a housing clamping part 3111; and the mounting clamping part 3122 is in snap-in connection with the housing clamping part 3111, so that the accommodating housing 311 is connected to the mounting sheet 312. By the arrangement of the above structure, during use, due to the design of the mounting clamping part 3122 and the housing clamping part 3111, the accommodating housing 311 and the mounting sheet 312 are clearly located during connection. This locating helps to achieve a standardized assembling process, so that each accommodating housing 311 can be accurately connected to the mounting sheet 312 according to a design requirement.

In this embodiment, the mounting clamping part 3122 includes a plurality of clamping slots 3123; the housing clamping part 3111 includes a plurality of clamping plates 3112; the clamping plates 3112 are in snap-in connection with the clamping slots 3123; and the mounting clamping part 3122 is connected to the housing clamping part 3111. By the arrangement of the above structure, during use, due to the design in which the plurality of clamping slots 3123 and the plurality of clamping plates 3112, the number of connecting points between the accommodating housing 311 and the mounting sheet 312 is increased. Compared with a single clamping structure, the multiple connecting points can disperse a force. When the plant growing lamp is subjected to an external force such as collision, shaking, or vibration in different environments, the multiple connecting points jointly bear the external force, thus effectively preventing the accommodating housing 311 from being loosened or falling off from a clip.

In this embodiment, the accommodating housing 311 is further provided with a pre-mounting slot 3115. By the arrangement of the above structure, during use, the pre-mounting slot 3115 is configured to mount an additional expanded lamp body 100. For a user who has already purchased and used the plant growing lamp, the presence of the pre-mounting slot 3115 facilitates later upgrade and renovation.

In this embodiment, the pre-mounting slot 3115 is formed by outward sinking of an inner wall of the accommodating housing 311, and the pre-mounting slot 3115 does not penetrate through the accommodating housing 311. By the arrangement of the above structure, during use, since the pre-mounting slot 3115 does not penetrate through the accommodating housing 311, when viewed from the appearance, the original overall shape and continuity of the appearance of the accommodating housing 311 will not be damaged from an external perspective. The entire plant growing lamp still visually appears as a relatively complete and coordinated whole, without appearing abrupt or damaging the overall aesthetic design due to the presence of an obvious penetrating structure. The plant growing lamp meets a requirement for the appearance design of the product and improves the quality of visual experience of the product. Secondly, this design facilitates the unified layout and planning of the additional expanded lamp body 100. All expanded components are mounted in the pre-mounting slot 3115, so that the entire plant growing lamp can maintain a proper positional relationship between the components according to the design intention while expanding the function of the entire plant growing lamp. This is conducive to achieving a more orderly and beautiful lighting layout adjustment, better meeting a requirement of plant growth for a lighting environment, and also facilitating a user to visually control and manage an overall state of the plant growing lamp. Since the pre-mounting slot 3115 is formed by the outward sinking of the inner wall of the accommodating housing 311, and the pre-mounting slot 3115 does not penetrate through the accommodating housing 311, the inner wall where the pre-mounting slot 3115 is located is relatively thinner than inner walls at other positions. The difficulty of penetration it is relatively low, making it easier for the pre-mounting slot 3115 to penetrate through the inner wall to mount the additional expanded lamp body 100.

In this embodiment, at least one pre-mounting slot 3115 is provided. By the arrangement of the above structure, the pre-mounting slot 3115 provides a convenient mounting space for upgrade and renovation of the lamp during use. The additional expanded lamp body 100 can be accommodated in the free pre-mounting slot 3115, thereby achieving the upgrade of the lamp and prolonging the service life of the lamp. There may be one or more pre-mounting slots 3115.

In this embodiment, the lamp body 100 includes a light-emitting main body 110, a connecting wire 120, and a flexible coil 130. The connecting wire 120 includes a current output end 121 and a current input end 122. The current output end 121 of the connecting wire 120 is electrically connected to the light-emitting main body 110. The current input end 122 of the connecting wire 120 is electrically connected to the power supply 200 The flexible coil 130 includes a first end 131 and a second end 132. The light-emitting main body 110 is attached to the first end 131 of the flexible coil 130. The connecting wire 120 is arranged in the flexible coil 130. The upper clip body 310 is attached to the second end 132 of the flexible coil 130. By the arrangement of the above structure, the flexible coil 130 provides a flexible supporting mode for the overall structure of the lamp during use. The light-emitting main body 110 is attached to the first end 131 of the flexible coil 130, and the upper clip body 310 is attached to the second end 132 of the flexible coil 130, so that a connection is established between the light-emitting main body 110 and the upper clip body 310 through the flexible coil 130. This connection mode allows for flexible adjustment of the position of the light-emitting main body 110 relative to the upper clip body 310 within a range, making it convenient to change an angle and direction of the light-emitting main body 110 according to a lighting requirement. Meanwhile, as the connecting wire 120 is located in the flexible coil 130, the flexible coil 130 can play a role of protecting the connecting wire 120.

In this embodiment, an accommodating space 313 and a power connection wire 314 are arranged in the accommodating housing 311; the accommodating housing 311 is provided with a wire hole 3116; the accommodating housing 311 defines the accommodating space 313; the wire hole 3116 is provided in the accommodating housing 311; the wire hole 3116 is communicated to the accommodating space 313; the accommodating space 313 is configured to accommodate the power connection wire 314; and the power connection wire 314 is configured to integrate the current input end 122 of the connecting wire 120. By the arrangement of the above structure, during use, the power connection wire 314 integrates the current input end 122 of the connecting wire 120, which can make a circuit where the power supply 200 supplies power to the lamp body 100 more concise and orderly. This integration mode avoids a need of the power supply 200 to be respectively connected to a plurality of connecting wires 120, thereby reducing the circuit complexity. Meanwhile, the power connection wire 314 in the accommodating space 313 can be flexibly wired according to the type and connection requirement of the power supply 200. If the power supply 200 is an external power supply, the power connection wire 314 can be connected to a proper plug or wiring terminal. If the power supply is an internal power supply such as a battery, the wiring mode can be easily adjusted to achieve reliable electrical connection.

In this embodiment, the wire hole 3116 is provided in a side wall of the accommodating housing 311. By the arrangement of the above structure, the wire hole 3116 is provided in the side wall during use, which is beneficial for preventing water and dust. When a small amount of water or dust falls in an environment, since the wire hole 3116 is not located at the top, it is not easy for the water and the dust to directly enter the accommodating housing 311 through the wire hole 3116. Moreover, some simple waterproof and dustproof structures can be designed around the wire hole 3116, such as a rubber sealing ring or a dust-proof cap, to further enhance the protection for internal electrical components and improve the electrical safety.

In this embodiment, a circuit board 315 is further arranged in the accommodating housing 311. The power connection wire 314 integrates the current input end 122 of the connecting wire 120 through the circuit board 315. By the arrangement of the above structure, during use, due to the circuit design on the circuit board 315, current input from the power supply can be accurately controlled and distributed, ensuring that each part can obtain a stable and appropriate current supply. For example, in a lamp body 100 composed of a plurality of LED lamp modules, different modules may have different requirements for current. The circuit board 315 can distribute the current appropriately according to an actual situation to avoid damage to a module due to excessive current or avoid a failure of normally emitting light due to insufficient current.

In this embodiment, the light-emitting main body 110 includes at least one LED lamp module. By the arrangement of the above structure, during use, under a normal usage condition, the life of an LED lamp can reach tens of thousands of hours, which is much longer than that of a traditional incandescent lamp. Moreover, since the LED lamp module itself has a relatively simple structure and is not easy to damage, its maintenance requirement is relatively low. Meanwhile, the LED lamp modules generate less heat, thereby reducing a desired additional maintenance measure due to heat dissipation, such as mounting a complex heat dissipation device, and further reducing the maintenance costs and difficulty.

In this embodiment, the accommodating housing 311 is provided with a mounting hole 3117; a mounting part 1321 is arranged at the second end 132 of the flexible coil 130; and the mounting hole 3117 is fixedly connected to the mounting part 1321, so that the flexible coil 130 is connected to the accommodating housing 311. By the arrangement of the above structure, during assembling, the fixed connection between the mounting hole 3117 and the mounting part 1321 provides a clear assembling position and a clear assembling mode. A worker can conveniently insert the mounting part 1321 of the flexible coil 130 into the mounting hole 3117 of the accommodating housing 311 for fixation according to a design requirement, which improves the efficiency and accuracy of assembling.

In this embodiment, the mounting part 1321 includes a nut 1322 and a threaded pipe 1323; the threaded pipe 1323 is in threaded connection to the nut 1322 after passing through the mounting hole 3117, so that the flexible coil 130 is connected to the accommodating housing 311. By the arrangement of the above structure, during use, the threaded connection between the nut 1322 and the threaded pipe 1323 can provide a stable and firm fixing effect. After the threaded pipe 1323 passes through the mounting hole 3117, a high clamping force can be generated by tightening the nut 1322, thereby tightly fixing the flexible coil 130 to the accommodating housing 311. During the mounting, this connection mode is relatively simple and easy to operate. The connection can be completed by threading the threaded pipe 1323 through the mounting hole 3117 and tightening the threaded pipe 1323 with the nut 1322.

### Embodiment 2

In this embodiment, the accommodating housing 311 is provided with an upper hinge part 3121; the lower clip body 320 is provided with a lower hinge part 321; and the upper hinge part 3121 is hinged to the lower hinge part 321, so that the mounting sheet 312 is rotatably connected to the lower clip body 320. By the arrangement of the above structure, during use, the accommodating housing 311 and the lower clip body 320 are movably connected to form a clamping part of the fixing device 300. This structure enables the clamping part to adapt to supporting objects with different shapes and sizes.

In this embodiment, the mounting sheet 312 is provided with a mounting clamping part 3122; the accommodating housing 311 is provided with a housing clamping part 3111; and the mounting clamping part 3122 is in snap-in connection with the housing clamping part 3111, so that the accommodating housing 311 is connected to the mounting sheet 312. By the arrangement of the above structure, during use, the mounting sheet 312 can be detachably connected to the accommodating housing 311, which provides a convenient operation access for mounting an electrical component. By opening the mounting sheet 312, the electrical component can be easily placed into the accommodating space 313 without worrying about difficulty in operation due to a narrow space or obstruction of other components.

In this embodiment, the mounting clamping part 3122 includes a plurality of clamping slots 3123; the housing clamping part 3111 includes a plurality of clamping plates 3112; the clamping plates 3112 are in snap-in connection with the clamping slots 3123; and the mounting clamping part 3122 is connected to the housing clamping part 3111. By the arrangement of the above structure, when the electrical component in the accommodating housing 311 needs to be maintained, inspected, or replaced during use, the clamping connection mode also makes it easy to remove the mounting sheet 312. Maintenance personnel can easily locate a clamping position and separate the mounting clamping part 3122 from the housing clamping part 3111 by simple operation, thereby opening the mounting sheet 312 and conveniently touching the electrical component inside, without using a complex tool.

### Embodiment 3

In this embodiment, the accommodating housing 311 is provided with a clamping sliding chute 3113; and a contour of the clamping sliding chute 3113 is matched with an edge contour of the mounting sheet 312, so that the mounting sheet 312 is slidably connected to the accommodating housing 311. By the arrangement of the above structure, during use, the design in which the clamping sliding chute 3113 is matched with the edge contour of the mounting sheet 312 makes the mounting sheet 312 slidably connected to the accommodating housing 311. During the assembling of the lamp, this slidable connection mode is easy to operate. The mounting can be completed by aligning an edge of the mounting sheet 312 with the clamping sliding chute 3113 and gently pushing the mounting sheet into the clamping sliding chute. Compared with a traditional mode such as screw fixation, this slidable connection mode does not require a tool, so that the mounting efficiency is greatly improved.

### Embodiment 4

In this embodiment, the accommodating housing 311 is provided with a housing threaded part 3114; the mounting sheet 312 is provided with a mounting threaded part 3124; and the housing threaded part 3114 is in threaded connection to the mounting threaded part 3124, so that the accommodating housing 311 is detachably connected to the mounting sheet 312. By the arrangement of the above structure, during use, due to the threaded connection between the housing threaded part 3114 and the mounting threaded part 3124, to mount the lamp, the connection between the accommodating housing 311 and the mounting sheet 312 can be completed by aligning the mounting threaded part 3124 of the mounting sheet 312 with the housing threaded part 3114 of the accommodating housing 311 and then rotating the mounting sheet 312. This connection mode is relatively simple and does not require a complex tool or a special mounting skill. An ordinary user can easily complete the mounting.

As described above, one or more embodiments are provided in conjunction with the detailed description, The specific implementation of the present disclosure is not confirmed to be limited to that the description is similar to or similar to the method, the structure and the like of the present disclosure, or a plurality of technical deductions or substitutions are made on the premise of the conception of the present disclosure to be regarded as the protection of the present disclosure.

1. A plant growing lamp, comprising: a lamp body, a power supply, and a fixing device, wherein the fixing device comprises an upper clip body and a lower clip body; the upper clip body is hollow; one end of the lamp body is inserted from the upper clip body and is fixed; and the power supply is electrically connected to the lamp body.

2. The plant growing lamp according to claim 1, wherein the upper clip body comprises an accommodating housing and a mounting sheet; the lamp body is fixed to the accommodating housing; and the accommodating housing is detachably connected to the mounting sheet.

3. The plant growing lamp according to claim 2, wherein the mounting sheet is provided with an upper hinge part; the lower clip body is provided with a lower hinge part; and the upper hinge part is hinged to the lower hinge part, so that the mounting sheet is rotatably connected to the lower clip body.

4. The plant growing lamp according to claim 2, wherein the accommodating housing is provided with an upper hinge part; the lower clip body is provided with a lower hinge part; and the upper hinge part is hinged to the lower hinge part, so that the mounting sheet is rotatably connected to the lower clip body.

5. The plant growing lamp according to claim 3, wherein the mounting sheet is provided with a mounting clamping part; the accommodating housing is provided with a housing clamping part; and the mounting clamping part is in snap-in connection with the housing clamping part, so that the accommodating housing is connected to the mounting sheet.

6. The plant growing lamp according to claim 5, wherein the mounting clamping part comprises a plurality of clamping slots; the housing clamping part comprises a plurality of clamping plates; the clamping plates are in snap-in connection with the clamping slots; and the mounting clamping part is connected to the housing clamping part.

7. The plant growing lamp according to claim 4, wherein the mounting sheet is provided with a mounting clamping part; the accommodating housing is provided with a housing clamping part; and the mounting clamping part is in snap-in connection with the housing clamping part, so that the accommodating housing is connected to the mounting sheet.

8. The plant growing lamp according to claim 7, wherein the mounting clamping part comprises a plurality of clamping slots; the housing clamping part comprises a plurality of clamping plates; the clamping plates are in snap-in connection with the clamping slots; and the mounting clamping part is connected to the housing clamping part.

9. The plant growing lamp according to claim 4, wherein the accommodating housing is provided with a clamping sliding chute; and a contour of the clamping sliding chute is matched with an edge contour of the mounting sheet, so that the mounting sheet is slidably connected to the accommodating housing.

10. The plant growing lamp according to claim 3, wherein the accommodating housing is provided with a housing threaded part; the mounting sheet is provided with a mounting threaded part; and the housing threaded part is in threaded connection to the mounting threaded part, so that the accommodating housing is detachably connected to the mounting sheet.

11. The plant growing lamp according to claim 2, wherein the accommodating housing is further provided with a pre-mounting slot.

12. The plant growing lamp according to claim 11, wherein the pre-mounting slot is formed by outward sinking of an inner wall of the accommodating housing, and the pre-mounting slot does not penetrate through the accommodating housing.

13. The plant growing lamp according to claim 12, wherein at least one pre-mounting slot is provided.

14. The plant growing lamp according to claim 2, wherein the lamp body comprises a light-emitting main body, a connecting wire, and a flexible coil; the connecting wire comprises a current output end and a current input end; the current output end of the connecting wire is electrically connected to the light-emitting main body; the current input end of the connecting wire is electrically connected to the power supply; the flexible coil comprises a first end and a second end; the light-emitting main body is attached to the first end of the flexible coil; the connecting wire is arranged in the flexible coil; and the upper clip body is attached to the second end of the flexible coil.

15. The plant growing lamp according to claim 14, wherein an accommodating space and a power connection wire are arranged in the accommodating housing; the accommodating housing is provided with a wire hole; the accommodating housing defines the accommodating space; the wire hole is provided in the accommodating housing; the wire hole is communicated to the accommodating space; the accommodating space is configured to accommodate the power connection wire; and the power connection wire is configured to integrate the current input end of the connecting wire.

16. The plant growing lamp according to claim 15, wherein the wire hole is provided in a side wall of the accommodating housing.

17. The plant growing lamp according to claim 15, wherein a circuit board is further arranged in the accommodating housing; and the power connection wire integrates the current input end of the connecting wire through the circuit board.

18. The plant growing lamp according to claim 14, wherein the light-emitting main body comprises at least one light-emitting diode (LED) lamp module.

19. The plant growing lamp according to claim 14, wherein the accommodating housing is provided with a mounting hole; a mounting part is arranged at the second end of the flexible coil; and the mounting hole is fixedly connected to the mounting part, so that the flexible coil is connected to the accommodating housing.

20. The plant growing lamp according to claim 19, wherein the mounting part comprises a nut and a threaded pipe; the threaded pipe is in threaded connection to the nut after passing through the mounting hole, so that the flexible coil is connected to the accommodating housing.
